(19) United States
(12) Patent Application Publication
(10) Pub. No.: US 2024/0159892 A1
(43) Pub. Date: May 16, 2024

(54) NON-LINE-OF-SIGHT RADAR APPARATUS

(71) Applicant: SAMSUNG ELECTRO-MECHANICS CO., LTD., Suwon-si (KR)

(72) Inventors: Young-Seo PARK, Suwon-si (KR); Han-Sang CHO, Suwon-si (KR); Ki-Bong CHONG, Suwon-si (KR); Byong-Hyok CHOI, Suwon-si (KR)

(73) Assignee: SAMSUNG ELECTRO-MECHANICS CO., LTD., Suwon-si (KR)

(21) Appl. No.: 18/280,729

(22) PCT Filed: Jun. 9, 2022
(86) PCT No.: PCT/KR2022/008143

§ 371 Date: Sep. 7, 2023

(30) Foreign Application Priority Data
Jun. 10, 2021 (KR) 10-2021-0075454
Dec. 8, 2021 (KR) 10-2021-0174657

(51) Int. Cl. G01S 13/931; G01S 7/35; G01S 13/42; G01S 13/46

(52) U.S. Cl. CPC G01S 13/931; G01S 7/354; G01S 13/42; G01S 2013/464

(57) ABSTRACT

A non-line-of-sight radar apparatus includes a first radar receiver to convert a first frequency radar signal received through a non-line-of-sight into a digital signal and to output a first path signal; a first signal processor to receive a second path signal from a direct-line-of-sight detection apparatus detecting a direct-line-of-sight, to cancel a direct-line-of-sight signal irrelevant to the non-line-of-sight included in the first path signal using the second path signal, and to extract a non-line-of-sight signal; and a first signal detector to detect an object on a non-line-of-sight based on the non-line-of-sight signal.

### TECHNICAL FIELD

The following description relates to a non-line-of-sight radar apparatus.

### BACKGROUND ART

Generally, radar may detect an object by transmitting radio waves in a direct-line-of-sight region and receiving reflected radio waves. However, radio waves may be transmitted through reflection, diffraction, and transmission even though the waves are not in the direct-line-of-sight region. Generally, such a signal may be weak and may interfere with detection of an object in a direct-line-of-sight region, such that the signal may be regarded as noise and may be removed.

However, it may be necessary to detect a vehicle behind a building, such that a technique for detecting an object in a non-line-of-sight using information on a geographical feature and reflected multipath radio waves has been developed for military or aviation use.

As the level of an autonomous driving vehicle or an advanced driver-assistance systems (ADAS) vehicle, which is a previous stage thereof, increases, a large amount of sensors required for autonomous driving has been added, which may include cameras, lidar, radar and ultrasonic sensors. These sensors may complement each other and may gradually detect nearby objects more accurately than human does, contributing to autonomous driving performance and stability.

However, all currently developed sensors may not detect a non-line-of-sight. Light, radio waves, and sound waves may be reflected, diffracted, and transmitted, but in reality, there is no vehicle camera, lidar, radar, or ultrasonic sensor detecting through a non-line-of-sight. Also, there may be a case in which a person, a bicycle, or a child covered by a vehicle or a wall may suddenly emerge in a parking lot or a narrow alley and an accident may occur, but there may be no apparatus for detecting an object in a non-line-of-sight in a vehicle.

In Non-Line-Of-Sight Radar, 2019, of Brian Watson, a technique of detecting a vehicle moving behind a building in the city from an aircraft using a 9 GHz X-band or 18 GHz Ku-band radar has been suggested. To this end, multipath radio waves reflected more than once on the building may be used, and information on the position and shape of the reflected building may be used. However, the information of such a building may require pre-researched topographical information such as Google Earth, which may be disadvantageous.

Accordingly, it may be difficult to detect a continuously changing obstacle, such as a parked vehicle. Also, when the detection target is small, such as a small child, not a vehicle, it may be difficult to detect the target with such a mid-range radar technique for aviation, which may be problematic.

Another research on non-line-of-sight radar data may be “Seeing Around Street Corners: Non-Line-of-Sight Detection and Tracking In-the-Wild Using Doppler Radar,” 2020, a research paper by Mercedes-Benz and Princeton. In this case, the non-line-of-sight region may be detected through a reflected signal using an original camera or lidar, and for practical use, the detection was implemented using a 77 GHz radar of an existing vehicle.

However, in this case, as a high-frequency radar of 77 GHz is used, reflected waves may be detected, but a diffraction or transmitted signal may not be used. In case in which a frequency is high, radar may have a small size, but path loss may occur and diffraction transmission ability may be significantly lowered. Accordingly, a person approaching from a place in which a reflection path is not secured may not be detected at all, which may be problematic.

### DISCLOSURE

### Technical Problem

One embodiment of the present invention provides non-line-of-sight radar apparatus that can detect a body such as a person approaching by a vehicle on a non-line-of-sight (NLOS) invisible to the naked eye in a parking lot or narrow alley, etc.

### Technical Solution

In one general aspect, a non-line-of-sight radar apparatus includes a first radar receiver configured to convert a first frequency radar signal received through a non-line-of-sight into a digital signal and to output a first path signal; a first signal processor configured to receive a second path signal from a direct-line-of-sight detection apparatus detecting a direct-line-of-sight, to cancel a direct-line-of-sight signal irrelevant to the non-line-of-sight included in the first path signal using the second path signal and to extract a non-line-of-sight signal; and a first signal detector configured to detect an object on a non-line-of-sight based on the non-line-of-sight signal.

The first frequency radar signal may use a first path frequency lower than a second path frequency of a second frequency radar signal used in the direct-line-of-sight detection apparatus.

The first path signal may include a non-line-of-sight signal acquired through the non-line-of-sight, an NLOS-related direct line-of-sight signal, and an NLOS-independent direct line-of-sight signal.

The first signal processor may be configured to remove the NLOS-independent direct line-of-sight signal from the first path signal using the second path signal and to generate the non-line-of-sight signal including the NLOS-related direct line-of-sight signal.

The first signal detector may be configured to receive the non-line-of-sight signal from the first signal processor, and to detect the object on the non-line-of-sight using an artificial intelligence (AI) algorithm constructed by performing AI learning.

The first signal processor may be configured to extract a Doppler pattern signal with respect to the first path signal.

The first signal detector may be configured to receive target position information and the Doppler pattern signal from the non-line-of-sight signal, and to detect the object on the non-line-of-sight using an artificial intelligence (AI) algorithm constructed by performing AI learning.

The first signal processor may be configured to perform a cancellation operation using the second path signal from which the non-line-of-sight signal is removed and the first path signal including the non-line-of-sight signal.

In another general aspect, a non-line-of-sight radar apparatus includes a first radar configured to receive a first frequency radar signal through a non-line-of-sight; and a second radar configured to receive a second frequency radar signal through a direct-line-of-sight, wherein the first radar includes a first radar receiver configured to convert the first frequency radar signal into a digital signal and to output a first path signal; a first signal processor configured to cancel a direct-line-of-sight signal irrelevant to the non-line-of-sight included in the first path signal using a second path signal provided from the second radar and to extract a non-line-of-sight related signal; and a first signal detector configured to detect an object on a non-line-of-sight based on the non-line-of-sight signal.

The first frequency radar signal may use a first path frequency lower than a second path frequency of the second frequency radar signal.

The first path signal may include a non-line-of-sight signal obtained through the non-line-of-sight, an NLOS-related direct line-of-sight signal, and an NLOS-independent direct line-of-sight signal.

The first signal processor may be configured to remove the NLOS-independent direct line-of-sight signal from the first path signal using the second path signal and to generate the non-line-of-sight signal including the NLOS-related direct line-of-sight signal.

The first signal detector may be configured to receive the non-line-of-sight signal from the first signal processor, and to detect the object on the non-line-of-sight using an artificial intelligence (AI) algorithm constructed by performing AI learning.

The first signal processor may be configured to generate a Doppler pattern signal with respect to the first path signal.

The first signal detector may be configured to receive target position information and a Doppler pattern signal from the non-line-of-sight signal, and to detect the object on the non-line-of-sight using an artificial intelligence (AI) algorithm constructed by performing AI learning.

The first signal processor may be configured to perform a cancellation operation using the second path signal from which the non-line-of-sight signal is removed and the first path signal including the non-line-of-sight signal.

In another general aspect, a non-line-of-sight radar apparatus includes a radar receiver configured to convert a first frequency radar signal received through a non-line-of-sight into a digital signal and to output a first path signal; a signal processor configured to receive a second path signal from a direct-line-of-sight detection apparatus detecting a direct-line-of-sight, to cancel a direct-line-of-sight signal irrelevant to the non-line-of-sight included in the first path signal using the second path signal and to extract a non-line-of-sight signal; and a signal detector including a non-line-of-sight Artificial Intelligence (AI) algorithm, and configured to detect an object on the non-line-of-sight using the non-line-of-sight AI algorithm with respect to the non-line-of-sight signal and to output a detection signal.

The AI algorithm may be generated through pre-learning for the non-line-of-sight signal.

Other features and aspects will be apparent from the following detailed description, the drawings, and the claims.

### Advantageous Effects

According to the aforementioned examples, using the non-line-of-sight (NLOS) AI radar apparatus, objects such as people approaching to a vehicle on a non-line-of-sight, which are invisible to the naked eye, may be detected in a parking lot or narrow alley.

For example, by detecting in advance small children who are invisible by a wall or a parked vehicle and suddenly jumps out, accidents may be prevented in advance. Also, the movement of an adult or a bicycle may be detected in advance, such that the speed may be reduced and accidents may be prevented.

For example, the vehicle non-line-of-sight (NLOS) radar may be an auxiliary means of general vehicle radar, and may be applied to near-range detection not covered by obstacles, and the NLOS radar may be mounted as close as possible to the general vehicle radar such that detection efficiency may increase. For example, the NLOS radar may be mounted as close as possible to the vehicle short range radar (SRR) on the left and right sides of the front bumper, or may be implemented in a combo-module including the SRR radar.

### DESCRIPTION OF DRAWINGS

FIG. 1 is a diagram illustrating a non-line-of-sight radar apparatus according to an example.

FIG. 2 is a diagram illustrating a non-line-of-sight radar apparatus according to an example.

FIG. 3 is a diagram illustrating a first signal processor.

FIG. 4 is a diagram illustrating a first signal processor and a second signal processor.

FIG. 5 is a diagram illustrating operations of a first signal detector.

FIG. 6 is a detection vehicle, surrounding vehicles, and surrounding people.

FIG. 7 is a diagram illustrating a point cloud detected by first radar in FIG. 6.

FIG. 8 is a diagram illustrating a point cloud detected by second radar in FIG. 6.

FIG. 9 is a diagram illustrating a point cloud detected in a non-line-of-sight by first radar in FIG. 6.

FIG. 10 is a diagram illustrating a point cloud detected by a non-line-of-sight radar apparatus.

Throughout the drawings and the detailed description, the same reference numerals refer to the same elements. The drawings may not be to scale, and the relative size, proportions, and depictions of elements in the drawings may be exaggerated for clarity, illustration, and convenience.

### MODE FOR INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

Hereinafter, various examples will be described as below with reference to the attached drawings.

In the drawings, same elements will be indicated by same reference numerals.

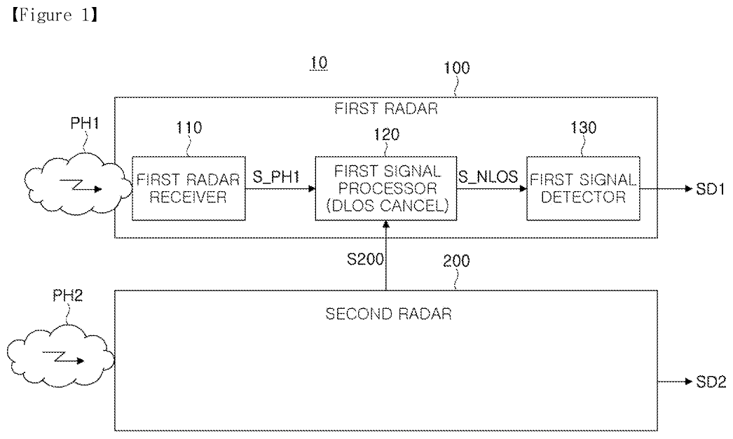

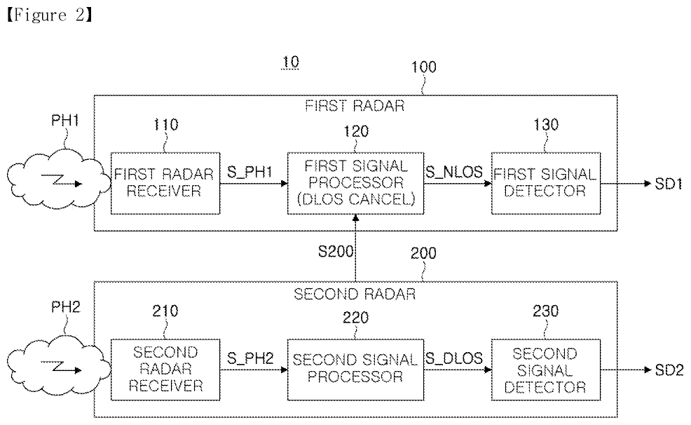

FIG. 1 is a diagram illustrating a non-line-of-sight radar apparatus according to an example. FIG. 2 is a diagram illustrating a non-line-of-sight radar apparatus according to an example.

Referring to FIGS. 1 and 2, the non-line-of-sight radar apparatus 10 may include at least a first radar 100 and a second radar 200.

In the example, the first radar 100 may be representative of a non-line-of-sight detection apparatus, and the second radar 200 may be representative of a direct-line-of-sight detection apparatus, and the non-line-of-sight detection apparatus will be described with reference to the first radar 100 as an example, and the direct-line-of-sight detection apparatus will be described with reference to the second radar 200, but a configuration thereof is not limited thereto, and an apparatus able to detect an object in a non-line-of-sight or a direct-line-of-sight may be used.

The first radar 100 may receive a first frequency radar signal through non-line-of-sight PH1 (or NLOS), may cancel a signal of direct-line-of-sight PH2 (or DLOS) irrelevant to the non-line-of-sight from the first frequency radar signal using the signal S200 provided from the second radar 200, may detect an object on the non-line-of-sight based on the non-line-of-sight signal, and may output the first detection signal SD1.

The second radar 200 may receive the second frequency radar signal through the direct-line-of-sight PH2 (or DLOS), may detect an object on the direct-line-of-sight based on the second frequency radar signal and may output a second detection signal SD2.

Generally, a vehicle radar may have different properties depending on a frequency thereof. For example, high-frequency radars may be configured to be small and to detect even small objects in fine detail. However, the high frequency radar may have a weak NLOS (non-line-of-sight) signal (reflected, diffraction, transmitted signal) such that the high frequency radar may not be suitable to be used as an NLOS radar. Accordingly, the NLOS radar may implement the NLOS detection function effectively using the low-frequency radar.

As an example, a 24 GHz radar was used in a vehicle in the past, and a 77 GHz radar may have been used in a vehicle recently.

In the example, a non-line-of-sight (NLOS) radar apparatus which may secure a reflected, diffracted, transmitted signal to the maximum using a frequency lower than a 77 GHz radar currently used may be provided.

In the example, a technique for distinguishing between a NLOS signal and a direct-line-of-sight (DLOS) signal may be provided.

For example, since the NLOS signal is weak as compared to the DLOS signal due to attenuation, a technique for distinguishing the signals may be necessary. In a stationary vehicle, a person moving behind a stationary obstacle such as a wall or a parked vehicle may be distinguished relatively easily through a difference in Doppler signals. However, when the vehicle moves, there may be difficultly in that a Doppler signal may be detected from all obstacles. Also, when a parked vehicle moves, there may be more difficulties. Accordingly, to effectively distinguish a DLOS signal stronger than the NLOS signal from the NLOS radar, it may be useful to use the DLOS signal detected by the second radar 200, which may be a sensor other than the first radar 100 which is the NLOS radar.

In other words, the NLOS signal portion of the NLOS radar may be effectively detected by matching the DLOS signal portion of the NLOS radar using a DLOS signal detected by a sensor other than the non-line-of-sight (NLOS) radar (first radar) and removing the portion. Generally, as the second radar 200, which is a DLOS radar, a 77 GHz radar generally used in a vehicle may be used. Accordingly, the first radar 100, which is a low-frequency NLOS radar, may be disposed in the same position as the second radar, which is a 77 GHz radar, and radio waves detected by the first and second radars 100 and 200 may be compared at about the same time point such that NLOS signal components of the NLOS radar may be effectively detected and distinguished.

Also, instead of the DLOS signal of the second radar 200, which is a 77 GHz radar, a DLOS signal component detected by a lidar, an ultrasonic wave, or a camera may be used. Accordingly, in the example, the NLOS signal distinct from the DLOS signal component of the NLOS radar may be effectively extracted using the DLOS signal obtained through the second radar 200 which is a sensor other than the first radar 100 which is the NLOS radar, the lidar, the ultrasonic wave or camera.

Also, in the example, in detecting the NLOS signal from the first radar, which is an NLOS radar, an artificial intelligence (AI) algorithm learning the position information of the target and also the Doppler pattern through deep learning may be used.

For example, the NLOS signal through reflected diffraction transmission, or the like, entering the first radar 100, which is the NLOS radar, may have a very different appearance depending on the path environment. Accordingly, it may be necessary to improve detection ability to detect the approach of a person in the NLOS area without error by repeatedly learning the signals generated in various environments. In this case, by reducing complexity of the AI algorithm and increasing accuracy by learning and detecting only the NLOS-related signals obtained by distinguishing and removing the DLOS signals irrelevant to the detection of the NLOS signals, performance thereof may greatly improve. Also, when the learning system is allowed even after the apparatus in the example is applied, it may be implemented to continuously learn NLOS detection and to share the learned information, such that performance of the NLOS radar may continuously improve and safety may increase.

The main configuration in the example of FIGS. 1 and 2 will be described below.

For example, the first radar 100 may include a first radar receiver 110, a first signal processor 120, and a first signal detector 130.

The first radar receiver 110 may convert the first frequency radar signal into a digital signal and may output a first path signal S_PH1.

For example, the first radar receiver 110 may include an antenna for receiving radio waves, and a front-end configured to convert an RF signal received through the antenna into a baseband signal and to convert an analog signal into a digital signal. The signal from the front-end may be output to the first signal processor 120.

For example, the first path signal S_PH1 of the first radar receiver 110 may include a non-line-of-sight signal S_NLOS acquired through the non-line-of-sight PH1, a NLOS-related direct line-of-sight (PH2) signal S_DLOS_1, and a NLOS independent direct line-of-sight signal S_DLOS_2.

The first signal processor 120 may receive the signal S200 (e.g., S_PH2) from the second radar 200, may cancel the direct-line-of-sight signal S_DLOS irrelevant to the non-line-of-sight from the first path signal S_PH1 using the signal S200 (e.g., S_PH2) and may generate the non-line-of-sight signal S_NLOS.

For example, the first signal processor 120 may generate a Doppler pattern signal with respect to the first path signal S_PH1. For example, the first signal processor 120 may remove the NLOS-related direct line-of-sight signal S_DLOS_2 from the first path signal S_PH1 using the second path signal S_PH2 and may generate the non-line-of-sight signal S_NLOS including NLOS related direct line-of-sight PH2.

In other words, the first signal processor 120 may perform the cancelling operation using the second path signal S_PH2 from which the non-line-of-sight signal S_NLOS is removed and the first path signal S_PH1 including the non-line-of-sight signal S_NLOS.

The first signal detector 130 may detect an object on the non-line-of-sight PH1 (or NLOS) based on the non-line-of-sight signal S_NLOS and may output a first detection signal SD1.

For example, the first signal detector 130 may receive the Doppler pattern signal of the non-line-of-sight signal S_NLOS, may perform artificial intelligence (AI), and may detect an object on the non-line-of-sight PH1 using a constructed AI algorithm.

Referring to FIG. 2, for example, the second radar 200 may include a second radar receiver 210, a second signal processor 220, and a second signal detector 230.

The second radar receiver 210 may convert the second frequency radar signal into a digital signal and may output the second path signal S_PH2.

The second signal processor 220 may remove a signal or noise of a level lower than a preset normal threshold from the second path signal S_PH2 from the second radar receiver 210 and may generate a direct-line-of-sight signal S_DLOS.

The second signal detector 230 may detect an object on the direct-line-of-sight PH2 (or DLOS) based on the direct-line-of-sight signal S_DOS and may output a second detection signal SD2.

*91 For example, the first frequency radar signal may use a first path frequency lower than a second path frequency of the second frequency radar signal used by the second radar 200.

For example, the second path frequency of the second frequency radar signal may be 77 GHz (e.g., a frequency in the range of 76 GHz to 81 GHz), and the first path frequency of the first frequency radar signal may be a frequency among frequencies included in the range of 1 GHz to 25 GHz, such as, for example, 7.5 GHz. However, the configuration thereof is not limited thereto.

In the above-described example, the first radar 100, which is a NLOS radar, may be mounted in the same position as the second radar 200, which is a 77 GHz vehicle radar mounted on a front bumper of a vehicle. If desired, the second radar 200, which is a 77 GHz DLOS radar for vehicle, and the first radar 100, which is a NLOS radar, may be configured in a combo module.

In other words, the second radar 200, which is a 77 GHz high-frequency DLOS radar, may detect an object on a direct-line-of-sight (Direct-Line-Of-Sight) using high-frequency radio waves on the DLOS. However, in the high-frequency DLOS radar, the signal through the NLOS may be weak and unclear for an object on the non-line-of-sight, which is invisible to the naked eye, such that the signal may be generally regarded as noise and may be removed.

On the other hand, in the first radar 100, which is a low-frequency NLOS radar, a visible object may be detected using a low-frequency radio wave of the DLOS, and an invisible object may also be detected using a low-frequency radio wave on the NLOS.

However, since the visible object is detected by the second radar 200, it may not be necessary to detect the first radar 100, and accordingly, the first radar 100 may focus on detecting the invisible object through the NLOS such that the NLOS detection efficiency may increase.

Accordingly, in the signal processing of the first radar 100, the signal component through the DLOS of the first radar 100 with the signal of the DLOS radar may be matched, canceled and removed, and the signal component through the NLOS may be extracted such that only invisible objects on the NLOS may be efficiently detected. In the signal processing of the first radar 100, an AI algorithm learned by deep learning may be used, and the more concise the learned signal, the greater the efficiency may be, such that the DLOS signal not relevant to NLOS detection may be removed in the process before execution of the AI algorithm.

In other words, even a DLOS signal may be used for learning without removing a signal relevant to the NLOS signal if desired. For example, a DLOS signal from an object causing an NLOS reflection may contribute to NLOS detection. Accordingly, in the example, a technique for extracting NLOS-related signals to increase the NLOS AI algorithm performance may also be provided.

The non-line-of-sight radar apparatus 10 in the example may include the first radar 100 and the second radar 200 and may be manufactured in a combo module, such that NLOS object detection performance may improve.

With respect to the drawings, unnecessary redundant descriptions of the components having the same reference numeral and the same function may not be provided, and differences will be described.

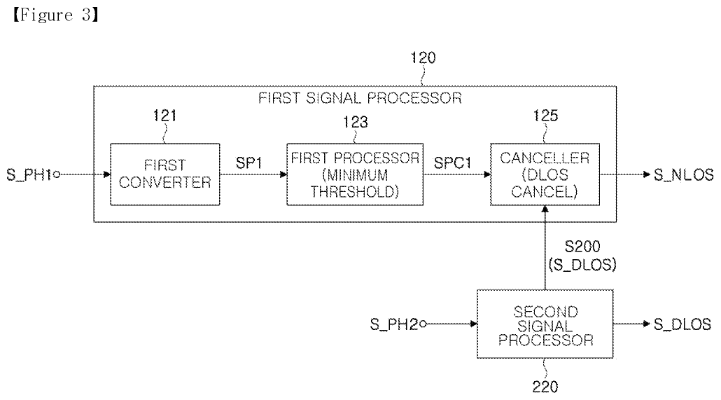

FIG. 3 is a diagram illustrating a first signal processor.

Referring to FIG. 3, the first signal processor 120 may include a first converter 121, a first processor 123, and a canceller 125.

The first converter 121 may perform FFT on the first path signal S_PH1 input from the first radar receiver 110, may derive a Doppler pattern using a Doppler algorithm and may output a first path point signal SP1 including information of a position and speed of an object.

The first processor 123 may remove a signal or noise of a level lower than a preset minimum threshold from the first path point signal SP1 from the first converter 121, and may generate a first path point cloud signal SPC1 including a plurality of detection points.

The canceller 125 may cancel a second path point cloud signal irrelevant to the non-line-of-sight from the first path point cloud signal SPC1 using the direct-line-of-sight signal S_DLOS provided from the second signal processor 220 of the second radar 200 in the first path point cloud signal SPC1 from the first processor 123, and may generate the non-line-of-sight signal S_NLOS.

In other words, the second radar 200, which is a DLOS radar, may remove the signal of the non-line-of-sight, but the first radar 100, which is the NLOS radar, may not remove or may remove the signal on the non-line-of-sight to the minimum, may detect an object, and may generate point cloud. The point cloud may indicate at which point an object is detected as a collection of detection points in a 2D or 3D map. Since the first radar 100, which is the NLOS radar, has a relatively lower frequency than the used frequency of the second radar 200, the NLOS signal may be more strongly detected. As an example, the second radar 200, which is a DLOS radar using a relatively high frequency (e.g., 77 GHz), may remove the NLOS signal of weak strength as described above. Accordingly, by removing the DLOS component from the point cloud detected by the first radar 100, including the NLOS component, using the point cloud which only detects the DLOS signal component through the second radar 200, only the NLOS-related component from which the DOS component is removed may be extracted.

Since the second radar 200 detects the NLOS signal (reflected/transmitted/diffracted wave) weaker than the first radar 100, generally, the DLOS point cloud does not include the NLOS signal. On the other hand, the first radar 100 may generate a point cloud including the NLOS signal by detecting the NLOS signal (reflected/transmitted/diffracted wave) more strongly. Accordingly, when the DLOS component unnecessary for NLOS detection is removed from the signal output from the first radar 100, complexity of the output signal may be reduced.

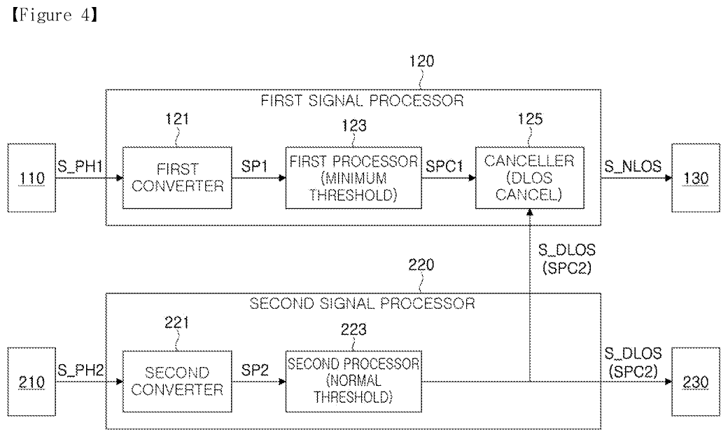

FIG. 4 is a diagram illustrating a first signal processor and a second signal processor.

Referring to FIG. 4, the first signal processor 120 may include a first signal converter 121, a first processor 123, and a canceller 125 as illustrated in FIG. 3. The detailed description thereof will be replaced with the description described with reference to FIG. 3.

The second signal processor 220 may include a second converter 221 and a second processor 223.

The second converter 221 may perform FFT on the second path signal S_PH2 input from the second radar receiver 210, may derive a Doppler pattern using a Doppler algorithm and may output second path point signal SP2 including information of position and speed of an object.

The second processor 223 may remove a signal or noise of a level lower than a preset normal threshold from the second path point signal SP2 from the second converter 221, and may generate the direct-line-of-sight signal S_DLOS including the second path point cloud signal SPC2 including a plurality of detection points.

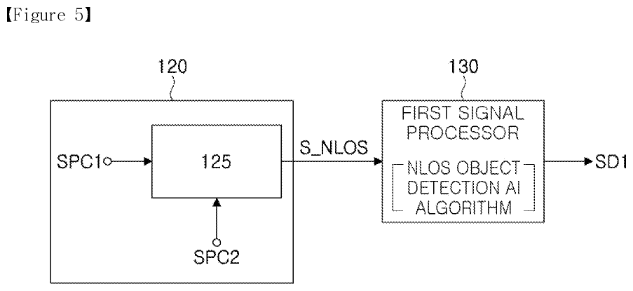

FIG. 5 is a diagram illustrating operations of a first signal detector.

Referring to FIG. 5, the first signal detector 130 may receive the non-line-of-sight signal S_NLOS from the first signal processor 120, may perform artificial intelligence (AI) learning, and may detect an object on the non-line-of-sight PH1 (or NLOS) using the NLOS object detection AI algorithm.

For example, the first signal detector 130 may include a NLOS (non-line-of-sight) Artificial Intelligence (AI) algorithm constructed through pre-learning for the non-line-of-sight signal S_NLOS, may detect an object on the non-line-of-sight PH1 using the NLOS AI algorithm with respect to the non-line-of-sight signal S_NLOS input from the canceller 125, and may output the first detection signal SD1.

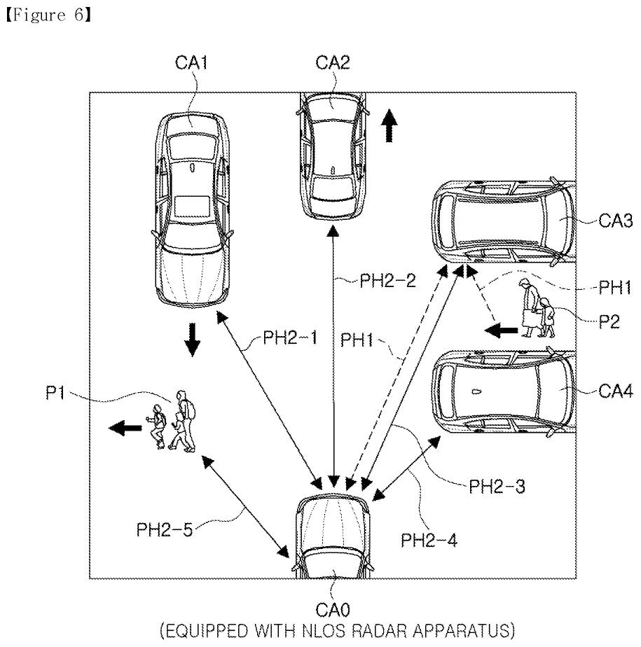

FIG. 6 is a detection vehicle, surrounding vehicles, and surrounding people.

In FIG. 6, CA0 is a detection vehicle equipped with the non-line-of-sight radar apparatus in the example, CA1 is a first vehicle traveling in a direction opposite to the travelling direction of detection vehicle CA0, CA2 is a second vehicle leading in the same direction as the travelling direction of the detection vehicle CA0, CA3 is a parked third vehicle, and CA4 is the fourth vehicle parked beside the third vehicle CA3. P1 is a person (or people) on the direct-line-of-sight, and P2 is a person (or people) on the non-line-of-sight.

Also, it may be assumed that the first person P1 may move away from the travelling direction of the first vehicle CA1 on the direct-line-of-sight PH2-4, and that second person P2 approaches in the travelling direction of the first vehicle CA1 on the non-line-of-sight PH1 that is not visible to the naked eye between the parked third vehicle CA3 and the fourth vehicle CA4.

In this case, the detection vehicle CA0, the first vehicle CA1, and the direct-line-of-sight DLOS (PH2-1) may be present, and the detection vehicle CA0, the second vehicle CA2, and the direct-line-of-sight DLOS (PH2-2) may be present, the detection vehicle CA0, the third vehicle CA3, and the direct-line-of-sight DLOS (PH2-3) may be present, the detection vehicle CA0, the fourth vehicle CA4, and a direct-line-of-sight DLOS (PH2-4) may be present, and the detection vehicle CA0, the first person P1, and the direct-line-of-sight DLOS (PH2-5) may be present, and the detection vehicle CA0, the second person P2 and the non-line-of-sight NLOS (PH1) may be present.

Here, the direct-line-of-sight DLOS (PH2-3) and the non-line-of-sight PH1 may be simultaneously present between the detection vehicle CA0 and the third vehicle CA3.

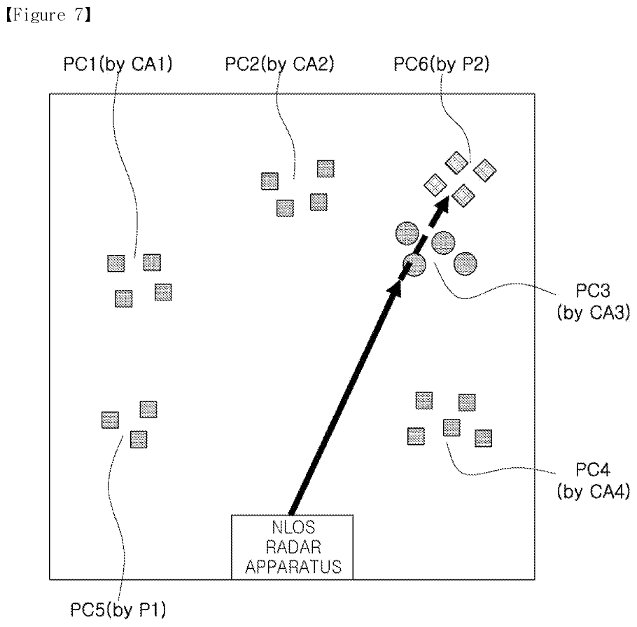

FIG. 7 is a diagram illustrating a point cloud detected by first radar in FIG. 6.

Referring to FIG. 7, the point cloud detected by the first radar 100 may include a first point cloud PC1 by the first vehicle CA1 on the direct-line-of-sight, a second point cloud PC2 by the second vehicle CA2 on the direct-line-of-sight, a third point cloud PC3 by the third vehicle CA3 on the direct-line-of-sight, a fourth point cloud PC4 by the fourth vehicle CA4 on the direct-line-of-sight, a fifth point cloud PC5 by the first person P1 on the direct-line-of-sight, and a sixth point cloud PC6 by the second person P2 on the non-line-of-sight.

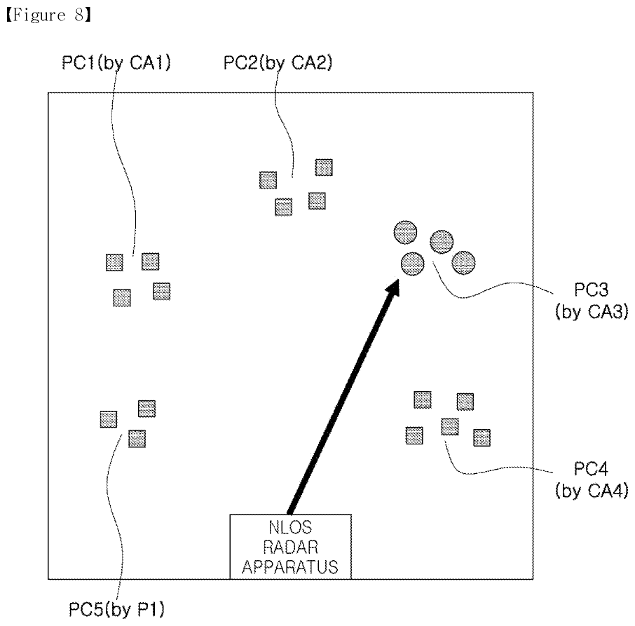

FIG. 8 is a diagram illustrating a point cloud detected by second radar in FIG. 6.

Referring to FIG. 8, the object detected by the second radar 200 may include a first point cloud PC1 by the first vehicle CA1 on the direct-line-of-sight, the second point cloud PC2 by the second vehicle CA2 on the direct-line-of-sight, the third point cloud PC3 by the third vehicle CA3 on the direct-line-of-sight, the fourth point cloud PC4 by the fourth vehicle CA4 on the direct-line-of-sight, and a fifth point cloud PC5 by the first person P1 on the direct-line-of-sight.

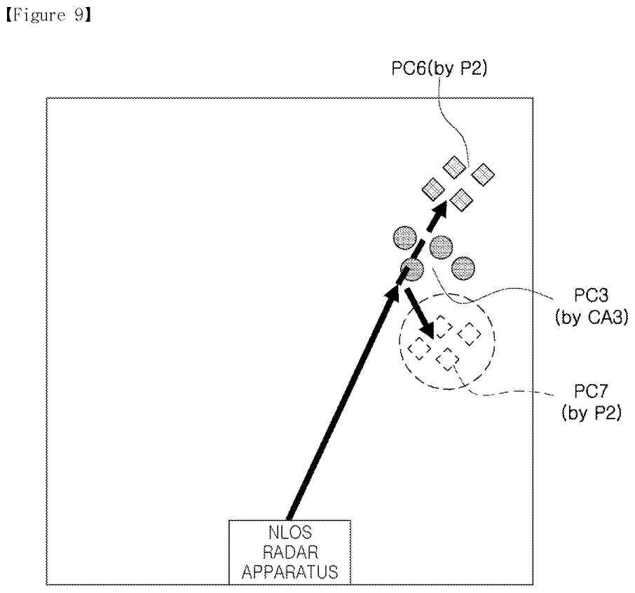

FIG. 9 is a diagram illustrating a point cloud detected in a non-line-of-sight by first radar in FIG. 6. In other words, FIG. 9 is a diagram illustrating an NLOS point cloud extracted for detecting an object on the non-line-of-sight, obtained by canceling a direct-line-of-sight signal not relevant to a non-line-of-sight by the first radar using the second radar signal in FIG. 6.

FIG. 9 illustrates the point clouds PC3 and PC6 remaining after the process of canceling the point clouds PC1 to PC5 irrelevant to the non-line-of-sight among the point clouds detected by the second radar 200 from the point cloud detected by the first radar 100.

FIG. 9 illustrates the third and sixth point clouds PC3 and PC6 present on the third direct-line-of-sight PH2-3 relevant to the non-line-of-sight PH1 and the non-line-of-sight PH1, and also illustrates a seventh point cloud PC7 in which an AI position estimation algorithm estimates a target position on the non-line-of-sight based on the third and sixth point clouds PC3 and PC6.

Through this example, in the example embodiment, using a data processing technique which may simplify the point cloud in FIG. 7 to the point cloud in FIG. 9, complexity of the NLOS object detection AI algorithm in FIG. 5 including the AI position estimation algorithm may be reduced, and object detection performance may improve.

Even when learning and constructing the NLOS AI algorithm, by learning from the point cloud data in FIG. 9 rather than the point cloud in FIG. 7, complexity of the NLOS AI algorithm may be reduced and accuracy may increase.

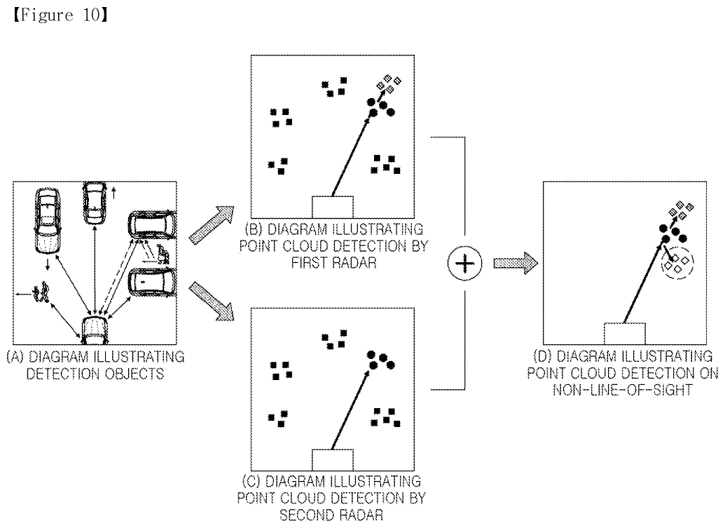

FIG. 10 is a diagram illustrating a point cloud detected by a non-line-of-sight radar apparatus.

Referring to FIG. 10, (A) is a diagram illustrating a detection target circumstance, (B) is a diagram illustrating point cloud detection by a first radar, (C) is a diagram illustrating point cloud detection by a second radar, and (D) is a diagram illustrating point cloud detection on the non-line-of-sight.

For example, when the detection target in (A) is detected by the first radar, the point cloud may be detected as illustrated in (B), and when the detection target in (A) is detected by the second radar, a point cloud may be detected as in (C). When the point cloud as illustrated in (C) is canceled from the detection point cloud as illustrated in (B), a point cloud relevant to a non-line-of-sight may be detected as illustrated in (D).

Thereafter, when the AI algorithm of the first signal processor 130 is applied to the point cloud relevant to the non-line-of-sight, the actual position of the NLOS object as indicated by a diamond in the dotted circle in (D) may be estimated.

For example, the non-line-of-sight radar apparatus in the example may include the first radar 100 and the second radar 200, but a configuration is not limited to the second radar 200, and any other sensor which may detect a direct-line-of-sight signal (DLOS) may be used. The NLOS signal distinguished from the DLOS signal component of the NLOS radar may be effectively extracted using the DLOS signal obtained using a sensor other than the second radar 200.

The NLOS AI radar using AI algorithm may detect NLOS objects efficiently using artificial intelligence (AI) algorithm constructed by learning the NLOS position signal and also Doppler patterns through deep learning.

For example, a signal indicating the third point cloud PC3 through the DLOS PH2-3 (third direct line-of-sight) and a signal indicating the sixth point cloud (PC6/PC7) through the NLOS PH1 (first direct line-of-sight) may come in the same direction, and the signal indicating PC6/PC7 may be much weaker, such that it is difficult to distinguish and detect the signal. However, since P2 is a moving object (e.g., a person) and CA3 is a stationary object (e.g., a vehicle), the Doppler patterns may be different and accordingly, the reception frequencies may be somewhat different, such that the signals may be distinguished the frequencies. Also, by analyzing this Doppler pattern in the AI algorithm, whether an object is approaching or moving away from the NLOS may be sensed, and the movement path over time may be predicted, thereby generating a warning signal for preventing accidents.

The above-described NLOS AI radar may use as low a frequency as possible as long as the size allows, such that the NLOS signal strength such as reflection, diffraction, and transmission may be secured to the maximum.

Referring to FIGS. 6 to 10, since the DLOS target is detected by the DLOS radar, there may be no need to detect the DLOS target in the NLOS radar, and only the NLOS target may be detected. Accordingly, as illustrated in FIG. 10, the DLOS signal components irrelevant to NLOS detection may be removed by canceling the component in the NLOS point cloud map. Then, only the weak NLOS signal component and the relevant DLOS component may remain. DLOS targets causing reflection, transmission, diffraction or relevant thereto may not be removed to accurately locate the position of NLOS target.

As such, in the NLOS radar, deep learning training may be performed with only the NLOS-relevant point cloud map to create an AI algorithm, and in practice, AI inferencing may be performed only using the point cloud map relevant to the NLOS, such that a target object may be effectively detected.

AI training (or learning) may determine the coefficient of the AI algorithm with a plurality of correct answer data, and as the more the learning is performed with the correct answer, the more the AI algorithm may be upgraded. The prediction of answer with data for which a given correct answer is unknown may be referred to as inferencing.

Only people P2 approaching in the travelling direction of the vehicle between the two parked cars CA4 and CA5 in FIG. 6 may appear as NLOS targets. The people P1 moving away from the left, the second vehicle CA2 ahead, or the approaching first vehicle CA1 may be detected as DLOS targets by the DLOS radar. Here, only one reflected NLOS signal may be considered. In this case, the third vehicle CA3 creating the reflected NLOS signal may be a DLOS target, but may not directly affect the NLOS signal, the signal may not be removed and may be included in AI training and inferencing.

FIG. 7 illustrates an example of a point cloud of the first radar 100, which is a NLOS low-frequency radar detecting both NLOS and DLOS, and FIG. 8 is an example of a point cloud of the radar 200, which is a DLOS high-frequency radar mainly detecting only DLOS.

In this case, when the NLOS-related DLOS points are removed by canceling the points, the NLOS-related point cloud map illustrated in FIG. 9 may be completed, and AI training and AI inferencing may be performed using the map and the NLOS target may be detected.

Here, the reason for removing the DLOS signal irrelevant to NLOS may be to reduce complexity of the NLOS AI algorithm and to increase the accuracy by learning only the NLOS-related portion by deep learning.

Also, FIG. 7 illustrates the NLOS point cloud signal output by the first processor 123 of the first radar 100 in FIG. 4 in a Bird's Eye View (BEV) form, a 2D point cloud display method. FIG. 8 is a diagram illustrating a DLOD point cloud signal output to the second processor 223 of the second radar 200 in FIG. 4 in the BEV form. Also, a portion in FIG. 9 other than NLOS Objects, which is a dotted line, may be a diagram illustrating a point cloud (NLOS related point cloud) signal relevant to the non-line-of-sight in FIG. 4 in the BEV form.

For example, as illustrated in FIG. 7, a circular DLOS point cloud PC3 corresponding to the third vehicle CA3 and a rhombus-shaped NLOS point cloud PC6 behind the vehicle may be detected, but as illustrated in FIG. 8, the rhombus-shaped point cloud may not be detected. Accordingly, the rhombus shape may be recognized as a NLOS signal and should not be visible because the shape is covered by the circular DLOS, but is visible, and accordingly, this rhombus shape may be estimated as a point cloud due to the reflected wave.

In FIG. 9, the circular DLOS point cloud PC3 and the rhombus-shaped NLOS point cloud PC6 causing a reflection may remain, and when this point cloud is inferred with an AI algorithm, the position of the target may be determined as in the NLOS point cloud PC7 marked the dotted line. Even when learning AI, learning may be performed with the point cloud in FIG. 9 and the correct answer sheet masking the actual position of the NLOS target. Accordingly, as illustrated in FIG. 9, the result of detecting the position of the dotted rhombus-shaped portion in the dotted circle in FIG. 9, that is, the NLOS objects, may be the result of AI algorithm inferencing.

Here, whether the third vehicle CA3 creates the NLOS signal may also be recognized because the second person P2 approaching behind the vehicle in FIG. 7 is detected. Generally, objects behind the same DLOS may be hidden or merged into a single object. Otherwise, the recognition in which the objects are distinct may indicate that the object is in the NLOS position. Also, when the objects are in NLOS, reflection, transmission, diffraction, or signals may be weakened and delayed, such that the object may appear farther away from the actual positions. Since only the case of reflection is assumed here, it may be estimated that the signal is reflected by the third vehicle CA3 such that the object is located in the position of the mirror image as illustrated in FIG. 9 and a little closer than the position.

As described above, uncertainty may increase by geometrically calculating the object illustrated in FIG. 9, probabilistic accuracy may increase using an AI algorithm using deep learning. Also, comparing the Doppler signals of approaching people with the Doppler signals of the stationary third vehicle CA3, the signal may be recognized as a NLOS signal more accurately.

Also, in the example, the NLOS signal may be detected using an AI algorithm, and the correct answer for training the AI algorithm may be provided in the form of a point cloud. The correct position of the person who is actually hidden may be projected on the point cloud detected by the first radar 100. Then, the AI algorithm may learn that the object is located in that position when such a signal is detected, and this learning may be repeated countless times.

For example, the second person P2 may be detected as a diamond point cloud on the circular point cloud as illustrated in FIG. 9 by performing training in advance in the product manufacturing stage, and the AI algorithm learns that that the actual position of the person is in the dotted point cloud below the circular point cloud, and that the position is the correct answer. When this learning is repeated countless times, this algorithm determines that there is a real person in the dotted line, not the solid line, by inferencing the trained AI algorithm when this NLOS-related signal comes in.

When too much irrelevant data is used during such training, performance of the AI algorithm may decrease, and accordingly, the DLOS point cloud irrelevant to NLOS may be removed and only the data relevant to NLOS detection may be used for training and inferencing. Data relevant to NLOS detection basically may include all data between the detected NLOS data (e.g., PC6) and the NLOS radar (e.g., PC3).

On the other hand, since the point cloud map is in the form of an image, a convolutional neural network (CNN) may be basically used, but various latest AI algorithms may also be used to improve performance. In particular, the time series AI algorithm may be used more effectively to identify the Doppler signal of the NLOS target and time-varying travelling path and to predict the future travelling path. This is because the ultimate utility of the NLOS radar may lie in predicting the path of an NLOS target which may collide by approaching the path of the vehicle, rather than simply detecting the NLOS target, so as to give a warning or to control the vehicle. In the Mercedes/Princeton thesis, both an image processing algorithm detecting the shape of an object, whether an object is a person or a bicycle, and a time series AI algorithm predicting the future position based on the past and present positions were used. For more effective NLOS detection, more diverse and advanced AI algorithms may be used in the future.

The example may be usefully used as an AI data processing technique of removing DLOS data irrelevant to NLOS considered as noise and extracting only NLOS-related data to operate the AI algorithms more efficiently.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A non-line-of-sight radar apparatus, comprising:
a first radar receiver configured to convert a first frequency radar signal received through a non-line-of-sight into a digital signal, and to output a first path signal;
a first signal processor configured to receive a second path signal from a direct-line-of-sight detection apparatus detecting a direct-line-of-sight, to cancel a direct-line-of-sight signal irrelevant to the non-line-of-sight included in the first path signal using the second path signal, and to extract a non-line-of-sight signal; and
a first signal detector configured to detect an object on a non-line-of-sight based on the non-line-of-sight signal.

2. The non-line-of-sight radar apparatus of claim 1, wherein the first frequency radar signal uses a first path frequency lower than a second path frequency of a second frequency radar signal used in the direct-line-of-sight detection apparatus.

3. The non-line-of-sight radar apparatus of claim 1, wherein the first path signal includes a non-line-of-sight signal acquired through the non-line-of-sight, an NLOS-related direct line-of-sight signal, and an NLOS-independent direct line-of-sight signal.

4. The non-line-of-sight radar apparatus of claim 3, wherein the first signal processor is configured to remove the NLOS-independent direct line-of-sight signal from the first path signal using the second path signal and to generate the non-line-of-sight signal including the NLOS-related direct line-of-sight signal.

5. The non-line-of-sight radar apparatus of claim 1, wherein the first signal detector is configured to receive the non-line-of-sight signal from the first signal processor, and to detect the object on the non-line-of-sight using an artificial intelligence (AI) algorithm constructed by performing AI learning.

6. The non-line-of-sight radar apparatus of claim 1, wherein the first signal processor is configured to extract a Doppler pattern signal with respect to the first path signal.

7. The non-line-of-sight radar apparatus of claim 6, wherein the first signal detector is configured to receive target position information and the Doppler pattern signal from the non-line-of-sight signal, and to detect the object on the non-line-of-sight using an artificial intelligence (AI) algorithm constructed by performing AI learning.

8. The non-line-of-sight radar apparatus of claim 1, wherein the first signal processor is configured to perform a cancellation operation using the second path signal from which the non-line-of-sight signal is removed and the first path signal including the non-line-of-sight signal.

9. A non-line-of-sight radar apparatus, comprising:
a first radar configured to receive a first frequency radar signal through a non-line-of-sight; and
a second radar configured to receive a second frequency radar signal through a direct-line-of-sight,
wherein the first radar comprises:
a first radar receiver configured to convert the first frequency radar signal into a digital signal and to output a first path signal;
a first signal processor configured to cancel a direct-line-of-sight signal irrelevant to the non-line-of-sight included in the first path signal using a second path signal provided from the second radar and to extract a non-line-of-sight related signal; and
a first signal detector configured to detect an object on a non-line-of-sight based on the non-line-of-sight signal.

10. The non-line-of-sight radar apparatus of claim 9, wherein the first frequency radar signal uses a first path frequency lower than a second path frequency of the second frequency radar signal.

11. The non-line-of-sight radar apparatus of claim 9, wherein the first path signal includes a non-line-of-sight signal obtained through the non-line-of-sight, an NLOS-related direct line-of-sight signal, and an NLOS-independent direct line-of-sight signal.

12. The non-line-of-sight radar apparatus of claim 11, wherein the first signal processor is configured to remove the NLOS-independent direct line-of-sight signal from the first path signal using the second path signal and to generate the non-line-of-sight signal including the NLOS-related direct line-of-sight signal.

13. The non-line-of-sight radar apparatus of claim 9, wherein the first signal detector is configured to receive the non-line-of-sight signal from the first signal processor, and to detect the object on the non-line-of-sight using an artificial intelligence (AI) algorithm constructed by performing AI learning.

14. The non-line-of-sight radar apparatus of claim 9, wherein the first signal processor is configured to generate a Doppler pattern signal with respect to the first path signal.

15. The non-line-of-sight radar apparatus of claim 9, wherein the first signal detector is configured to receive target position information and a Doppler pattern signal from the non-line-of-sight signal, and to detect the object on the non-line-of-sight using an artificial intelligence (AI) algorithm constructed by performing AI learning.

16. The non-line-of-sight radar apparatus of claim 9, wherein the first signal processor is configured to perform a cancellation operation using the second path signal from which the non-line-of-sight signal is removed and the first path signal including the non-line-of-sight signal.

17. A non-line-of-sight radar apparatus, comprising:
a radar receiver configured to convert a first frequency radar signal received through a non-line-of-sight into a digital signal and to output a first path signal;
a signal processor configured to receive a second path signal from a direct-line-of-sight detection apparatus detecting a direct-line-of-sight, to cancel a direct-line-of-sight signal irrelevant to the non-line-of-sight included in the first path signal using the second path signal, and to extract a non-line-of-sight signal; and
a signal detector comprising a non-line-of-sight Artificial Intelligence (AI) algorithm, and configured to detect an object on the non-line-of-sight using the non-line-of-sight AI algorithm with respect to the non-line-of-sight signal and to output a detection signal.

18. The non-line-of-sight radar apparatus of claim 1, wherein the AI algorithm is generated through pre-learning for the non-line-of-sight signal.
